(19) United States
(12) Patent Application Publication
(10) Pub. No.: US 2010/0088454 A1
(43) Pub. Date: Apr. 8, 2010

(54) Bridging device with power-saving function

(76) Inventors: Chi-Tung Chang, Taipei (TW); Shih-Min Lan, Taipei (TW); I-Chieh Lin, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/492,123

(22) Filed: Jun. 25, 2009

(30) Foreign Application Priority Data
Oct. 2, 2008 (TW) 097137909

(51) Int. Cl. G06F 13/20; G06F 1/32

(52) U.S. Cl. 710/313; 713/323

(57) ABSTRACT

A bridging device with power-saving function includes first and second interfaces, first and second physical layer processing devices, and a controller. The first interface is utilized for coupling a first external device complying with the first interface. The first external device receives a device request signal, and accordingly sends back a device response signal through the first physical layer processing device. The second interface is utilized for coupling a second external device complying with the second interface. The controller is coupled between the first and the second physical layer processing device for transmitting the device request signal with the predetermined frequency to the first physical layer processing device in order to receive the device response signal. When the controller does not receive the device response signal, the controller turns the second physical layer processing device off.

### BACKGROUND OF THE INVENTION

1. Field of the Invention

The present invention relates to a bridging device between two different interfaces, and more particularly, to a bridging device with power-saving function between two different interfaces.

2. Description of the Prior Art

In general, between two different interfaces, a bridging device is essential to be in charge of transforming the signal between two different interfaces. For example, when a Serial Advance Technology Attachment (SATA) hard drive is connected to a Universal Serial Bus (USB) interface of a computer for transmitting data, a bridging device is essential for transforming the signal of the SATA interface to be the signal of the USB interface or transforming the signal of the USB interface to be the signal of the SATA interface. More particularly, it is necessary to connect the bridging device between the SATA hard drive and the USB interface of the computer. However, when the conventional bridging device is only connected to the USB interface of the computer but not connected to the SATA hard drive, the conventional bridging device still remains operating, causing unnecessary energy consumption.

### SUMMARY OF THE INVENTION

The present invention provides a bridging device with power-saving function. The bridging device comprises a first interface, a first physical layer processing device, a second interface, a second physical layer processing device, and a controller. The first interface is utilized for coupling a first external device complying with the first interface. The first physical layer processing device is utilized for coupling to the first external device through the first interface. The first external device receives a device request signal through the first physical layer processing device and accordingly transmits a device response signal through the first physical layer processing device. The second interface is utilized for coupling to a second external device complying with the second interface. The second physical layer processing device is utilized for coupling to the second external device through the second interface. The controller is coupled between the first and the second physical layer processing devices for transmitting the device request signal with a first predetermined frequency to the first physical layer processing device in order to receive the device response signal. When the controller determines that the first interface is not coupled to the first external device, the controller turns the second physical layer processing device off.

The present invention further provides a bridging device with power-saving function. The bridging device comprises card interfaces, a controller, an insert/remove determination device, a physical layer processing device, and an interface. The card interfaces are utilized for coupling to corresponding cards and providing a plurality of corresponding insert/remove detection signals. A number of the card interfaces can be one or more. The controller is coupled to the card interfaces for accessing the cards in order to exchange and transform data of the cards. The insert/remove determination device is coupled to the card interfaces for receiving the insert/remove detection signals and accordingly generating a control signal. The physical layer processing device is coupled to the controller for physical layer processing of the data transformed from the controller. The physical layer processing device is selectively turned off according to the control signal. The interface is coupled to the physical layer processing device for coupling to an external device and transmitting a signal processed by the physical layer processing device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a bridging device with power-saving function of the present invention.

FIG. 2 is a diagram illustrating the bridging device of the present invention coupling two devices with different interface.

FIG. 3 is a diagram illustrating the bridging device of the present invention coupling only one device.

FIG. 4 is a diagram illustrating another embodiment derived from the bridging device of the present invention.

FIG. 5 is a diagram illustrating a card inserted into the bridging device of the present invention.

FIG. 6 is a diagram illustrating no card inserted into the bridging device of the present invention.

### DETAILED DESCRIPTION

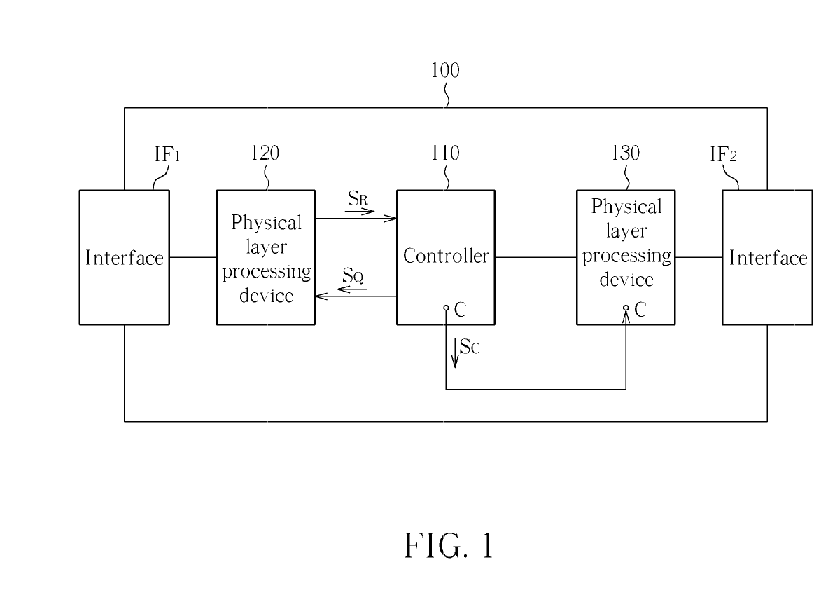

Please refer to FIG. 1. FIG. 1 is a diagram illustrating a bridging device 100 with power-saving function of the present invention. As shown in FIG. 1, the bridging device 100 comprises a controller 110, two physical layer processing devices 120 and 130, and two interfaces IF₁ and IF₂.

The interface IF₁, for example, is a SATA interface. The interface IF₂, for example, is a USB interface.

As described above, the interface IF₁ is a SATA interface. Therefore, the physical layer processing device 120 is utilized for processing the signal from the physical layer of the SATA interface. The interface IF₂ is a USB interface. Hence, the physical layer processing device 130 is utilized for processing the signal from the physical layer of the USB interface.

The controller 110 is utilized for transforming the signal processed by the physical layer processing device 120 and then transmitting the transformed signal to the physical layer processing device 130 so that the physical layer processing device 130 can output the signal complying with the IF₂ (USB) interface.

The controller 110 transmits a device request signal S_{Q} with a predetermined frequency F_{P1} to the physical layer processing device 120 so as to know if the interface IF₁ is coupled to any device complying with the interface IF₁ (In the condition described above, the device can be a SATA hard drive Y). If the interface IF₁ is coupled to the SATA hard drive Y, then the SATA hard drive Y generates a device response signal S_{R}. The device response signal S_{R} is then transmitted through the interface IF₁ and the physical layer processing device 120 to the controller 110 so as to notify the controller 110 that a SATA hard drive Y is coupled to the interface IF₁. On the contrary, if the interface IF₁ is not coupled to the SATA hard drive Y, then the physical layer processing device 120 does not generate the device response signal S_{R}. If the controller 110 has not received any device response signal S_{R} for a predetermined period, the controller 100 determines that there is no device coupled to the interface IF₁.

When the controller 110 determines that the interface IF₁ is coupled to a device (for example, the SATA hard drive Y), the controller 110 still transmits the device request signal S_{Q} with the predetermined frequency F_{P1} to continuously query if the device still exists, or determines if the device still exists according to the correctness of the response during the normal operation. On the contrary, when the controller 110 determines that the interface IF₁ is not coupled to the device (for example, the SATA hard drive Y), the controller reduces the frequency of generating the device request signal S_{Q}, for example, to the predetermined frequency F_{P2}, wherein the frequency F_{P2} is lower than the frequency F_{P1}. For example, if the controller 110 does not receive any device response signal S_{R} after transmitting the device request signal S_{Q} for predetermined number of times, the controller 110 determines that no device is coupled to the interface IF₁. In this way, when no device is coupled to the interface IF₁, it can reduce the frequency of the device request signal S_{Q} for saving the power consumption of the bridging device 100.

In addition, the controller 110, depending on if any device is coupled to the interface IF₁, also generates a control signal S_{C} to control the operation of physical layer processing device 130 (normal operation or stop). When the controller 110 determines that there is a device coupled to the interface IF₁ (for example, the SATA hard drive Y), the control signal S_{C} generated by the controller 110 turns on the physical layer processing device 130 so that the physical layer processing device 130 enters normal operation mode. On the contrary, when the controller 110 determines that no device is coupled to the interface IF₁ (for example, the SATA hard drive Y), the control signal S_{C} generated by the controller 110 turns off the physical layer processing device 130 for saving power consumed by the physical layer processing device 130. In such condition, when no device is coupled to the interface IF₁, it can turn off the physical layer processing device 130 for saving the power consumption of the bridging device 100.

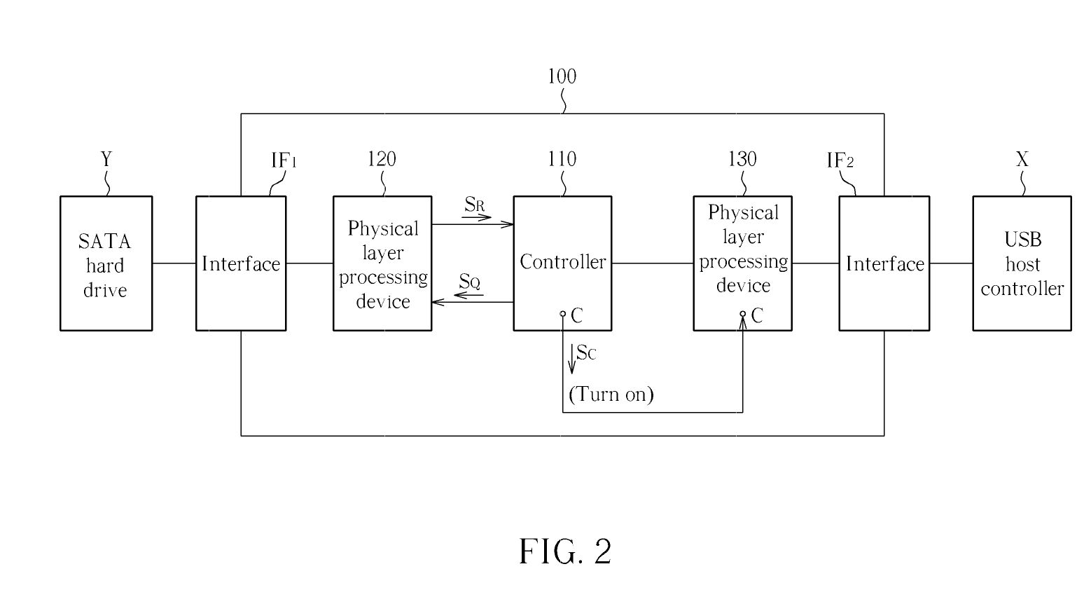

Please refer to FIG. 2. FIG. 2 is a diagram illustrating the bridging device of the present invention coupling two devices with different interface. As shown in FIG. 2, the SATA hard drive Y is coupled to the bridging device 100 of the present invention through the interface IF₁ (the SATA interface). A USB host controller X is coupled to the bridging device 100 of the present invention through the interface IF₂ (the USB interface). In such condition, the controller 110 turns on the physical layer processing device 130 for normal operation so that the USB host controller X can access the data stored in the SATA hard drive Y through the bridging device 100 of the present invention.

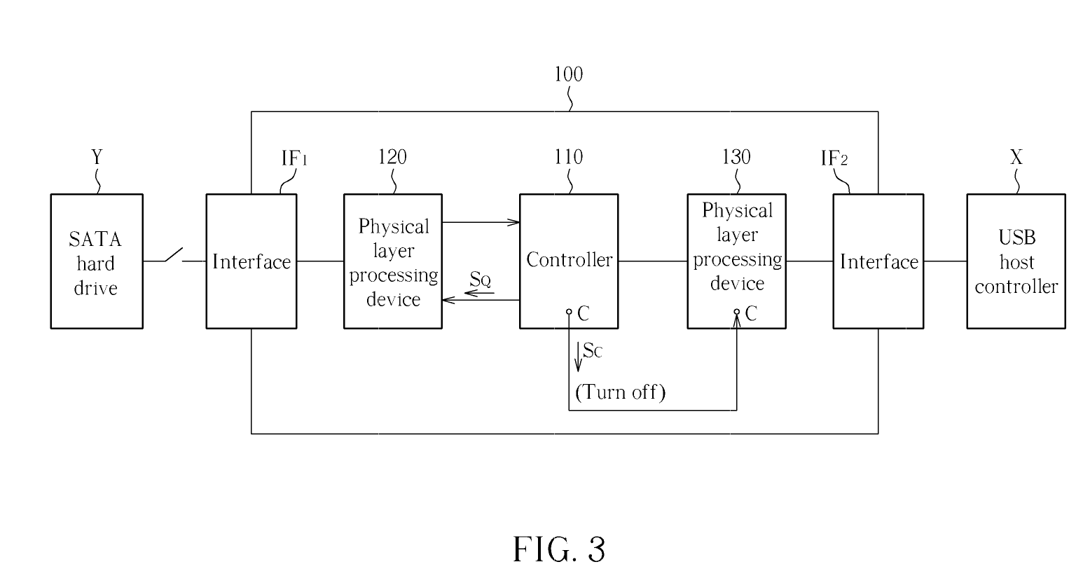

Please refer to FIG. 3. FIG. 3 is a diagram illustrating that the bridging device of the present invention is coupled to only one device. As shown in FIG. 3, the SATA hard drive Y is not coupled to the bridging device 100 of the present invention through the interface IF₁. The USB host controller X is coupled to the bridging device 100 of the present invention through the interface IF₂ (the USB interface). In this situation, because the bridging device 100 is not coupled to the SATA hard drive Y, the USB host controller X is not capable of accessing any data. Therefore, the controller 110 turns off the physical layer processing device 130 and reduces the frequency of generating the device request signal S_{Q} for saving the power consumption of the bridging device 100.

Furthermore, it is noticeable that the interfaces IF₁ and IF₂ are not limited to SATA or USB interfaces described above. The interface IF₂ can be any interface supporting hot-plug, for example, Peripheral Component Interconnect Express (PCIe) interface, SATA interface, External Serial Advance Technology Attachment (ESATA) interface, Personal Computer Memory Card International Association (PCMCIA) interface and so on. The interface IF₁ can be any transmission interface, for example, Recommended Standard 232 (RS-232) interface, parallel port (printer port) interface, Secure Digital Input Output (SDIO) interface, USB interface, and so on.

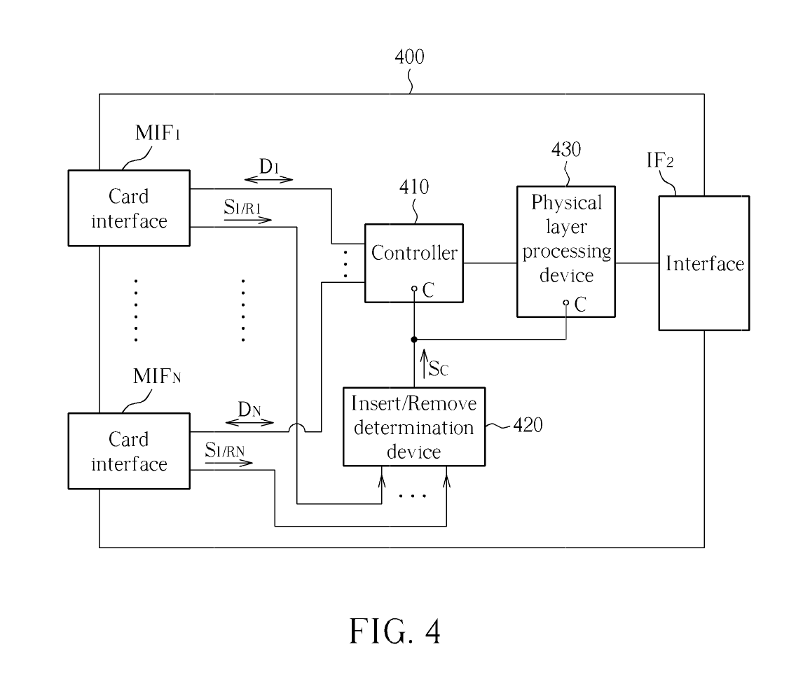

Please refer to FIG. 4. FIG. 4 is a diagram illustrating another embodiment derived from the bridging device of the present invention. The bridging device 400 is derived from the bridging device of the present invention. As shown in FIG. 4, the bridging device 400 can be realized with a card reader for accessing and outputting the data stored in the card.

The bridging device 400 comprises a controller 410, an insert/remove determination device 420, a physical layer processing device 430, an interface IF₂ and a plurality of card interfaces MIF₁˜MIF_{N}.

The interface IF₂ can be any interface supporting hot-plug, for example, PCIe interface, SATA interface, ESATA interface, USB interface or PCMCIA interface. The card interfaces MIF₁˜MIF_{N} can be any interface with the insert/remove detection mechanism, for example, Compact Flash Card (CF) interface, Secure Digital (SD) interface, Memory Stick Card (MS) interface, extreme Digital (XD) interface, Smart Media Card (SMC) interface, Multimedia Card (MMC) interface or IC card interface. All the card interfaces MIF₁˜MIF_{N} have a characteristic: when no card is inserted, the insert/remove detection signal S_{I/R} with the logic “1” is sent out; on the contrary, when a card is inserted, the insert/remove detection signal S_{I/R} with the logic “0” is sent out. For example, when the card interface MIF₁ is not inserted with a card, the insert/remove detection signal S_{I/R} with the logic “1” is sent out (represents no insertion or remove); on the contrary, when the card interface MIF₁ is inserted a card, the insert/remove detection signal S_{I/R} with the logic “0” is sent out (represents insertion). According to the different design of the card interface, the insert/remove detection signal S_{I/R} can represents insertion and removal by the opposite logic value.

The controller 410 is coupled to each of the card interfaces MIF₁˜MIF_{N}, the insert/remove determination device 420 and the physical layer processing device 430. The controller 410 is utilized for accessing each card M₁˜M_{N} in order to exchange and transform the data as required. More precisely, the controller 410 accesses data D₁˜D_{N} stored in the coupled cards through the card interfaces MIF₁˜MIF_{N}, then transforms and transmits the received data D₁˜D_{N} to the physical layer processing device 430 for the signal processing of the physical layer. The physical layer processing device 430 then processes the data received from the controller 410 for generating the signal complying the protocol of the interface IF₂ (the USB interface) and transmitting out the compliant signal through the interface IF₂.

The insert/remove determination device 420 is coupled to each of the card interfaces MIF₁˜MIF_{N}, the controller 410 and the physical layer processing device 430. The insert/remove determination device 420 is utilized for receiving each of the insert/remove detection signals S_{I/R1}˜S_{I/RN} and accordingly transmitting the control signal S_{C} to the controller 410 and the physical layer processing device 430. When any one of the insert/remove detection signals S_{I/R1}˜S_{I/RN} represents that a card is inserted, the insert/remove determination device 420 transmits the control signal S_{C} representing “turn on” to the controller 410 and the physical layer processing device 430. On the contrary, when all the insert/remove detection signals S_{I/R1}˜S_{I/RN} represent no card insertion (means removal), the insert/remove determination device 420 transmits the control signal S_{C} representing “turn-off” to the controller 410 and the physical layer processing device 430. Besides, the insert/remove determination device 420 can be realized with the logic gate(s). More particularly, the insert/remove determination device 420 can be embodied by an OR gate for realizing the required function.

When the controller 410 receives the control signal S_{C} representing “turn-off”, it means that the bridging device 400 is not coupled to any card at the time. Thus, the controller 410 enters the suspend/sleep mode for saving power consumption. However, according to the user's requirement, the controller 410 also can decide not to enter sleep mode when receiving the control signal S_{C} representing “turn-off”. On the contrary, when the controller 410 receives the control signal S_{C} representing “turn-on”, it means that the bridging device 400 is coupled to the card at the time. As a result, the controller 410 enters the normal operation mode for accessing the data stored in the coupled card.

When the physical layer processing device 430 receives the control signal S_{C} representing “turn-off”, it means that the bridging device 400 is not coupled to any card at the time. Therefore, the physical layer processing device 430 is turned off for saving power consumption. On the contrary, when the physical layer processing device 430 receives the control signal S_{C} representing “turn-on”, it means that the bridging device 400 is coupled to at least a card. Thus, the physical layer processing device 430 is turned on for physical layer processing of the signal received from the controller 410 so as to generate the signal complying the interface IF₂ (the USB interface) and transmitting the generated signal out through the interface IF₂.

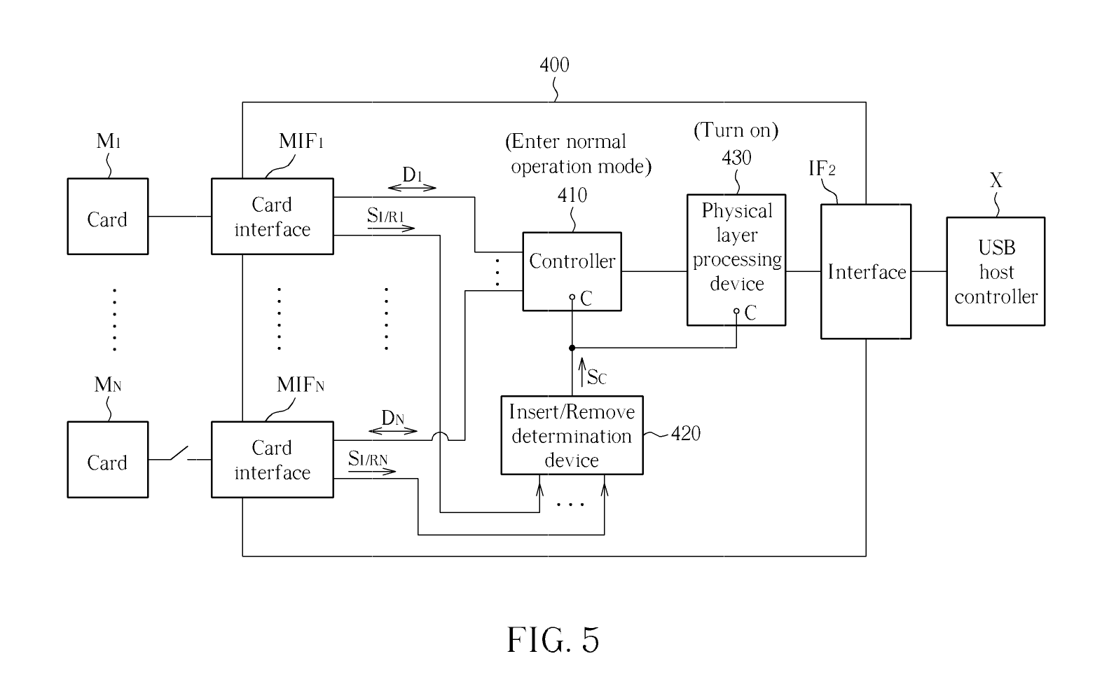

Please refer to FIG. 5. FIG. 5 is a diagram illustrating that a card is inserted into the bridging device 400 of the present invention. In FIG. 5, it is only illustrated as an example that when the card M₁ is inserted into the bridging device 400 and all the rest cards are not inserted into the bridging device 400 of the present invention. In addition, the bridging device 400 is coupled to the USB host controller X through the interface IF₂. As shown in FIG. 5, when the card M₁ is inserted into the bridging device 400 of the present invention through the corresponding card interface MIF₁, the card interface MIF₁ correspondingly triggers the insert/remove detection signal S_{I/R1} representing “insertion” and transmits the insert/remove detection signal S_{I/R1} to the insert/remove determination device 420. Once one of the received insert/remove detection signals S_{I/R1}˜S_{I/RN} of the insert/remove determination device 420 represents “insertion” (in this example, it is S_{I/R1}), the control signal S_{C} that represents “turn-on” is transmitted from the insert/remove determination device 420 so that the controller 410 enters the normal operation mode for transforming and transmitting the data D₁ provided by the card M₁ to the physical layer processing device 430. The physical layer processing device 430 is turned on as well so as to process the signal received from the controller 410 in the physical layer for generating the signal complying the protocol of the interface IF₂ (the USB interface) and transmitting the compliant signal to the USB host controller X through the interface IF₂. In this way, the USB host controller X is capable of accessing the data stored in the card M₁ through the bridging device 400.

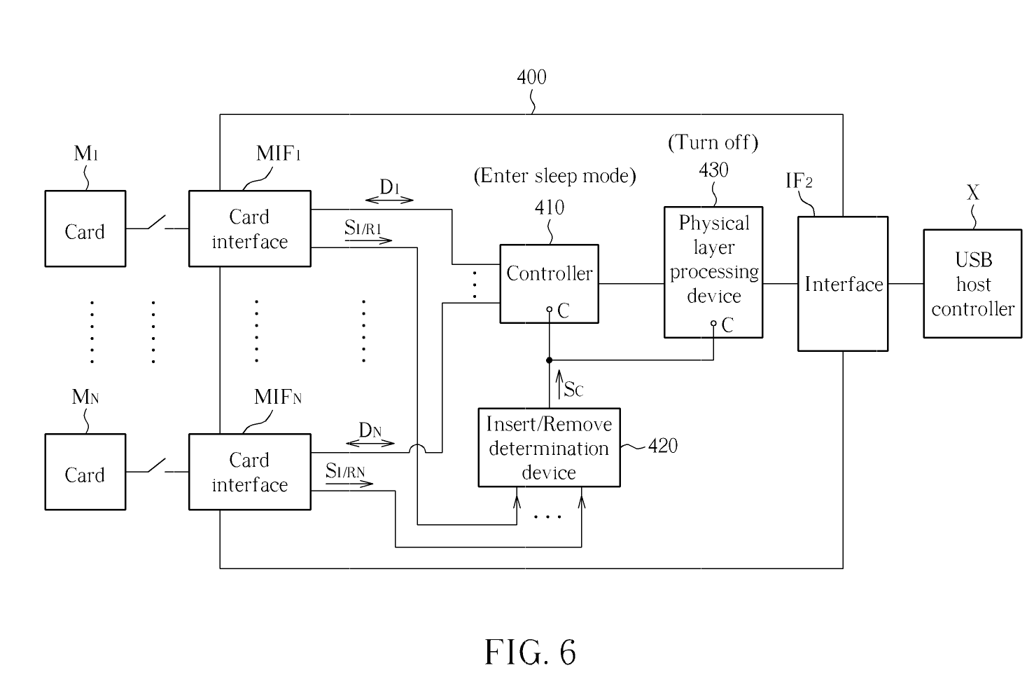

Please refer to FIG. 6. FIG. 6 is a diagram illustrating that no card is inserted into the bridging device 400 of the present invention. In FIG. 6, all the cards M₁˜M_{N} are not inserted into the bridging device 400. Besides, the bridging device 400 is coupled to the USB host controller X through the interface IF₂. As shown in FIG. 6, because there is no card inserted into the card interfaces MIF₁˜MIF_{N} of the bridging device 400 of the present invention, the card interfaces MIF₁˜MIF_{N} correspondingly trigger the insert/remove detection signals S_{I/R1}˜S_{I/RN} that represent “removal” and the insert/remove detection signals S_{I/R1}˜S_{I/RN} are transmitted to the insert/remove determination device 420. Meanwhile, all the received insert/remove detection signals S_{I/R1}˜S_{I/RN} of the insert/remove determination device 420 represent “removal”. Hence, the control signal S_{C} that represents “turn-off” is transmitted from the insert/remove determination device 420 so that the controller 410 enters the sleep mode and the physical layer processing device 430 is turned off as well. As a result, the bridging device 400 seems not exist for the USB host controller X. In this way, the bridging device 400 saves the power consumption when no card is inserted.

Furthermore, according to the design of the bridging device 400, the number of the card interface is not limited to be plural. In other words, the bridging device 400 can be designed to have only one card interface as desired. In such condition, the insert/remove determination device 420 is not the essential device. The controller 410 and the physical layer processing device 430 receive the insert/remove detection signals S_{I/R} directly from the card interface so as to determine if the controller 410 should enter sleep mode and the physical layer processing device 430 should be turned off.

In summary, by means of the bridging device of the present invention, when one of the ends of the bridging device is not coupled to the corresponding external device, the physical layer processing device is effectively turned off or the controller of the bridging device enters sleep mode for reducing the power consumption, which provides convenience.

Those skilled in the art will readily observe that numerous modifications and alterations of the device and method may be made while retaining the teachings of the invention.

What is claimed is:

1. A bridging device with power-saving function, comprising:
a first interface for coupling a first external device complying with the first interface;
a first physical layer processing device for coupling to the first external device through the first interface;
wherein the first external device receives a device request signal through the first physical layer processing device and accordingly transmits a device response signal through the first physical layer processing device;
a second interface for coupling to a second external device complying with the second interface;
a second physical layer processing device for coupling to the second external device through the second interface; and
a controller, coupled between the first and the second physical layer processing devices for transmitting the device request signal with a first predetermined frequency to the first physical layer processing device in order to receive the device response signal;
wherein when the controller determines that the first interface is not coupled to the first external device, the controller turns the second physical layer processing device off.

2. The bridging device of claim 1, wherein when the controller does not receive the device response signal after the device request signal is transmitted for a predetermined number of times, the controller determines that the first interface is not coupled to the first external device.

3. The bridging device of claim 1, wherein when the controller receives the device response signal before the device request signal is transmitted for a predetermined number of times, the controller determines that the first interface is coupled to the first external device.

4. The bridging device of claim 1, wherein when the controller determines the first interface is coupled to the first external device, the controller turns on the second physical layer processing device.

5. The bridging device of claim 1, wherein when the controller determines the first interface is not coupled to the first external device, the controller changes to transmit the device request signal with a second predetermined frequency;
wherein the second predetermined frequency is lower than the first predetermined frequency.

6. The bridging device of claim 1, wherein the first interface comprises any transmission interface, including a SATA interface, an RS-232 interface, a parallel port interface, an SDIO interface, or a USB interface.

7. The bridging device of claim 1, wherein the second interface comprises an interface supporting hot-plug, including a PCIe interface, a SATA interface, an ESATA interface, a USB interface, or a PCMCIA interface.

8. A bridging device with power-saving function, comprising:
card interfaces for coupling to corresponding cards and providing a plurality of corresponding insert/remove detection signals;
wherein a number of the card interfaces can be one or more;
a controller, coupled to the card interfaces for accessing the cards in order to exchange and transform data of the cards;
an insert/remove determination device, coupled to the card interfaces for receiving the insert/remove detection signals and accordingly generating a control signal;
a physical layer processing device, coupled to the controller for physical layer processing of the data transformed from the controller;
wherein the physical layer processing device is selectively turned off according to the control signal; and
an interface, coupled to the physical layer processing device for coupling to an external device and transmitting a signal processed by the physical layer processing device.

9. The bridging device of claim 8, wherein when a card is inserted into a corresponding card interface, a corresponding insert/remove detection signal provided by the card interface represents insertion; when the card is not inserted into the corresponding card interface, the corresponding insert/remove detection signal provided by the card interface represents removal.

10. The bridging device of claim 9, wherein when one of the insert/remove detection signals represents insertion, the control signal generated by the insert/remove determination device represents turn-on, and the controller enters normal operation mode; when all of the insert/remove detection signals represent removal, the control signal generated by the insert/remove determination device represents turn-off, and the controller enters sleep mode for saving power.

11. The bridging device of claim 8, wherein the card interfaces comprise any card interface providing insert/remove detection signals, including a CF interface, an SD interface, an MS interface, an XD interface, an SMC interface, an MMC interface, or an IC card interface.

12. The bridging device of claim 8, wherein the interface comprises an interface supporting hot-plug, including a PCIe interface, a SATA interface, an ESATA interface, a USB interface, or a PCMCIA interface.
